(19) United States
(12) Patent Application Publication
(10) Pub. No.: US 2017/0064655 A1
(43) Pub. Date: Mar. 2, 2017

(54) MULTI-ANTENNA RECEIVER PROCESSING

(71) Applicant: QUALCOMM Incorporated, San Diego, CA (US)

(72) Inventor: Louay Jalloul, San Jose, CA (US)

(21) Appl. No.: 14/835,235

(22) Filed: Aug. 25, 2015

(51) Int. Cl. H04W 56/00

(52) U.S. Cl. CPC H04W 56/0005; H04W 56/0035; H04W 56/005; H04W 84/042

(57) ABSTRACT

Methods, systems, and devices are described for wireless communications. A wireless device may process a first data signal sample using a wireless local area network (WLAN) processing path in a first receive chain of the wireless device. The wireless device processes a second data signal sample using a wireless wide area network (WWAN) processing path in a second receive chain of the wireless device. The wireless device time aligns the second data signal sample with the first data signal sample for data processing.

### BACKGROUND

Field of the Disclosure

The present disclosure relates to wireless communication systems, and more particularly to multi-antenna processing.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) includes an access point (AP) that communicates with one or more stations (STAs) or mobile devices. The AP can be coupled to a network, such as the Internet, and enable a mobile device to communicate via the network (and/or communicate with other devices coupled to the access point).

Many wireless communication devices, e.g., STAs, are capable of operating over both a WLAN and a wireless wide area network (WWAN) (e.g., long term evolution (LTE) or other cellular radio access technology (RAT)). These devices typically have separate hardware receive chains for WLAN and WWAN communications.

### SUMMARY

The present description discloses techniques for multi-antenna processing using a WWAN receive chain and one or more WWAN antenna(s) to increase spatial diversity in WLAN communications. According to these techniques, a wireless communication device, e.g., a STA, leverages alignment and synchronization functions in a WLAN receive chain to enable secondary WLAN reception using a WWAN receive chain. The WLAN receive chain performs preamble detection, automatic gain control (AGC), and packet detection functions, and uses a common or shared oscillator to identify timing and frequency synchronization functions shared with the WWAN receive chain. The WWAN receive chain, once synchronized with the WLAN receive chain, receives WLAN signals using WWAN antennas, WWAN analog radio frequency (RF) components, and a WWAN baseband. The WLAN signals received using the WWAN receive chain are provided to the WLAN receive chain. The communication device uses a time-domain buffer to align samples from the WWAN and WLAN receive chains to implement diversity reception, thereby addressing the disparity between processing latencies of the WLAN and WWAN receive chains. A converged baseband modem therefore processes WLAN streams from both WLAN and WWAN antennas.

A method for wireless communication is described. The method includes: processing a first data signal sample using a wireless local area network (WLAN) processing path in a first receive chain of a wireless device; processing a second data signal sample using a wireless wide area network (WWAN) processing path in second receive chain of the wireless device; and time aligning the second data signal sample with the first data signal sample for data processing.

The method can include delaying the processing of the second data signal sample using the WWAN processing path relative to the processing of the first data signal sample using the WLAN processing path. Processing the second data signal sample using the WWAN processing path can be delayed a predetermined amount of time. The method can include detecting a data packet using the WLAN processing path, and using the packet detection via the WLAN processing path for the processing of the second data signal sample using the WWAN processing path.

The method can include determining a carrier frequency offset correction using the WLAN processing path, and using the determined carrier frequency offset correction for the processing of the second data signal sample using the WWAN processing path. The method can include determining a timing using the WLAN processing path, and using the determined timing for the processing of the second data signal sample using the WWAN processing path. The method can include determining a first common phase error correction via the processing of the first data signal sample using the WLAN processing path, and separately determining a second common phase error correction via the processing of the second data signal sample using the WWAN processing path.

The method can include determining a gain control estimation using the WLAN processing path, and using the determined gain control estimation for initial gain control processing using the WWAN processing path. The method can include determining a time difference between processing using the WLAN processing path and processing using the WWAN processing path, and using the determined time difference to time align the second data signal sample with the first data signal sample. The method can include receiving a data signal via at least one WLAN antenna; providing the data signal received via the at least one WLAN antenna to the WLAN processing path; receiving the data signal via at least one WWAN antenna; and providing the data signal received via the at least one WWAN antenna to the WLAN processing path.

The method can include receiving a first data signal via at least one WLAN antenna; providing the first data signal to the WLAN processing path; receiving a second data signal via at least one WWAN antenna; and providing the second data signal antenna to the WLAN processing path, wherein the first data signal and the second data signal are different spatial streams.

A wireless device is described. The wireless device includes: a baseband modem to process a first data signal sample using a WLAN processing path in a first receive chain of the wireless device and process a second data signal sample using a WWAN processing path in a second receive chain of the wireless device; and a time domain buffer to time align the second data signal sample with the first data signal sample for data processing.

The baseband modem is further to delay the processing of the second data signal sample using the WWAN processing path relative to the processing of the first data signal sample using the WLAN processing path. The processing of the second data signal sample using the WWAN processing path can be delayed by a predetermined amount of time. The baseband modem is further to detect a data packet using the WLAN processing path; and wherein the baseband modem is further to use the packet detection via the WLAN processing path for the processing of the second data signal sample using the WWAN processing path.

The baseband modem is further to determine a carrier frequency offset correction using the WLAN processing path; and wherein the baseband modem is further to use the determined carrier frequency offset correction for the processing of the second data signal sample using the WWAN processing path. The baseband modem is further to determine a timing using the WLAN processing path; and wherein the baseband modem is further to use the determined timing for the processing of the second data signal sample using the WWAN processing path. The wireless device can include a WLAN analog front end to determine a first common phase error correction via the processing of the first data signal sample; and a WWAN analog front end to separately determine a second common phase error correction via the processing of the second data signal sample.

The baseband modem is further to determine a gain control estimation using the WLAN processing path; and further may include: a WWAN analog front end to use the determined initial gain control estimation for gain control processing to receive the second data signal sample. The baseband modem is further to determine a time difference between processing using the WLAN processing path and processing using the WWAN processing path and use the time domain buffer to time align the second data signal sample with the first data signal sample based at least in part on the determined time difference.

The data signal sample and the second data signal sample can be of the same spatial stream. The data signal sample and the second data signal sample can be of different spatial streams.

A wireless device is described. The wireless device includes: means for processing a first data signal sample using a wireless local area network (WLAN) processing path in a first receive chain of the wireless device; means for processing a second data signal sample using a wireless wide area network (WWAN) processing path in second receive chain of the wireless device; and means for time aligning the second data signal sample with the first data signal sample for data processing.

The wireless device can include means for delaying the processing of the second data signal sample using the WWAN processing path relative to the processing of the first data signal sample using the WLAN processing path. The means for processing the second data signal sample using the WWAN processing path can be delayed a predetermined amount of time. The wireless device can include means for detecting a data packet using the WLAN processing path; and means for using the packet detection via the WLAN processing path for the processing of the second data signal sample using the WWAN processing path.

The wireless device can include means for determining a carrier frequency offset correction using the WLAN processing path; and means for using the determined carrier frequency offset correction for the processing of the second data signal sample using the WWAN processing path. The wireless device can include means for determining a timing using the WLAN processing path; and means for using the determined timing for the processing of the second data signal sample using the WWAN processing path. The wireless device can include means for determining a first common phase error correction via the processing of the first data signal sample using the WLAN processing path; and means for separately determining a second common phase error correction via the processing of the second data signal sample using the WWAN processing path.

A non-transitory computer-readable medium storing code for wireless communication at a wireless device is described. The code can include instructions executable to cause the wireless device to: process a first data signal sample using a wireless local area network (WLAN) processing path in a first receive chain of the wireless device; process a second data signal sample using a wireless wide area network (WWAN) processing path in second receive chain of the wireless device; and time align the second data signal sample with the first data signal sample for data processing.

Further scope of the applicability of the described systems, methods, apparatus, or computer-readable media will become apparent from the following detailed description, claims, and drawings. The detailed description and specific examples are given by way of illustration only, and various changes and modifications within the scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a wireless communication system, such as a WLAN, that supports multi-antenna processing in accordance with various aspects of the present disclosure;

FIG. 2 shows an example of a block diagram of a device that supports multi-antenna processing in accordance with various aspects of the present disclosure;

FIG. 3 shows an example of a timing diagram that supports multi-antenna processing in accordance with various aspects of the present disclosure;

FIGS. 4A and 4B show block diagrams of examples of a STA that supports multi-antenna processing in accordance with various aspects of the present disclosure; and

FIG. 5 shows a flow chart that illustrate examples of methods for multi-antenna processing in accordance with various aspects of the present disclosure.

### DETAILED DESCRIPTION

According to aspects of the present disclosure, a wireless communication device, such as a wireless station (STA), utilizes techniques for multi-antenna processing that provide secondary wireless location area network (WLAN) reception using portions of a wireless wide area network (WWAN) receive chain. The device uses a WLAN radio frequency (RF) integrated circuit (RFIC) for down converting the WLAN signal and uses a baseband processor for primary processing of the WLAN frame, such as packet detection, automatic gain control (AGC), frequency correction, and timing correction. The WWAN RFIC processing is disengaged (or delayed) during packet detection, AGC estimation, frequency correction and timing correction. The WWAN RFIC processing is engaged after being informed by the WLAN RFIC that a packet has been detected. The WLAN RFIC also provides frequency correction (e.g., offset) to the WWAN RFIC, since a shared/common crystal oscillator is assumed to be used for both RFICs. The WWAN RFIC determines gain control based at least in part on a gain control estimation by the WLAN RFIC.

The WLAN RFIC generates a master clock signal and provides the master clock signal to the WWAN RFIC. The master clock signal is used to determine timing differences between WLAN and WWAN processing, and to time align signal samples from the WWAN RFIC with signal samples from the WLAN RFIC for data processing (e.g., decoding). With separate local oscillators for the WLAN RFIC and the WAN RFIC, the respective phase noise can be different. A common phase error (CPE) occurs on the receive chains from each of the WLAN and the WWAN RFICs. The CPE is corrected by the baseband processor for receive chains from the WLAN and the WWAN.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

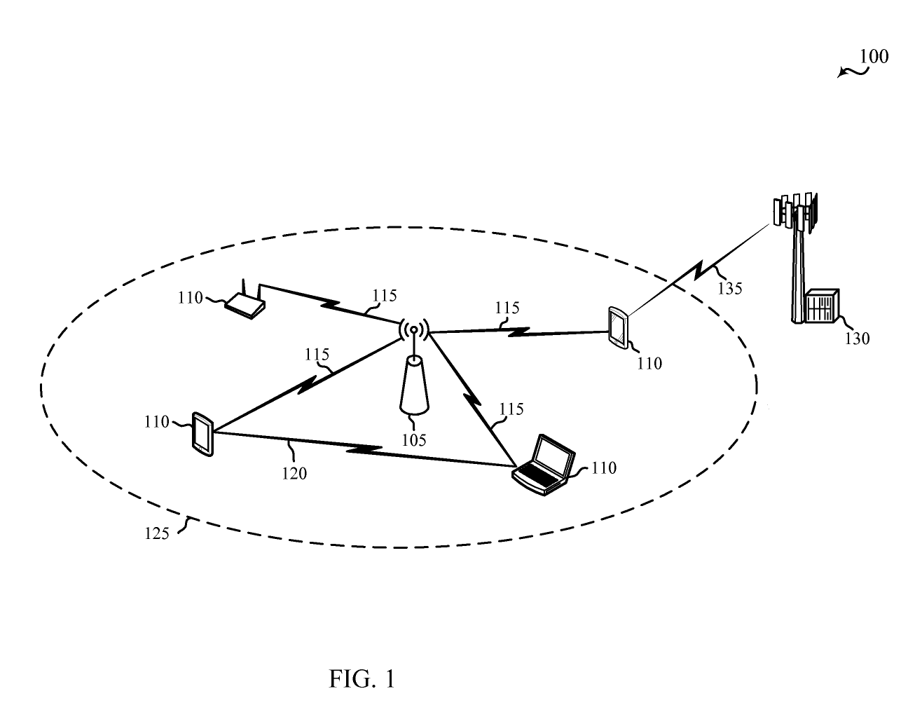

Referring first to FIG. 1, a block diagram illustrates an example of a wireless local area network (WLAN) 100 in accordance with various aspects of the present disclosure. The WLAN 100 includes an access point (AP) 105 and STAs 110. The STAs 110 can be mobile handsets, tablet computers, personal digital assistants (PDAs), other handheld devices, netbooks, notebook computers, tablet computers, laptops, desktop computers, display devices (e.g., TVs, computer monitors, etc.), printers, etc. While only one AP 105 is illustrated, the WLAN 100 can have multiple APs 105. STAs 110 can also be referred to as a mobile stations (MS), mobile devices, access terminals (ATs), user equipment (UEs), subscriber stations (SSs), or subscriber units. The STAs 110 associate and communicate with the AP 105 via a communication link 115. Each AP 105 has a coverage area 125 such that STAs 110 within that area are within range of the AP 105. The STAs 110 are dispersed throughout the coverage area 125. STAs 110 can be stationary or mobile. Some APs 105 and STAs 110 have multiple antennas.

While, the STAs 110 are capable of communicating with each other through the AP 105 using communication links 115, STAs 110 can also communicate directly with each other via direct wireless communication links 120. Direct wireless communication links can occur between STAs 110 regardless of whether any of the STAs is connected to an AP 105. Examples of direct wireless communication links 120 include Wi-Fi Direct connections, connections established by using a Wi-Fi Tunneled Direct Link Setup (TDLS) link, and other peer-to-peer (P2P) group connections.

The STAs 110 and APs 105 shown in FIG. 1 communicate according to the WLAN radio and baseband protocol including physical (PHY) and medium access control (MAC) layers from IEEE 802.11 and its various versions including, but not limited to, 802.11a, 802.11b, 802.11g, 802.11n, 802.11ac, 802.11ad, 802.11ah, 802.11aj, 802.11ax, 802.11ay, etc. Thus, WLAN 100 implements a contention-based protocol that allows a number of devices (e.g., STAs 110 and APs 105) to share the same wireless medium (e.g., a channel) without pre-coordination. To prevent several devices from transmitting over the channel at the same time, each device in the WLAN 100 operates according to certain procedures that structure and organize medium access, thereby preventing interference between the devices.

One or more STAs 110 are also capable of communicating with a wireless wide area network (WWAN) base station 130 via wireless communication link 135. WWAN base station 130 provides a coverage area for communication that implements a WWAN, such as a long term evolution (LTE) and/or LTE advanced (LTE-A) network. In LTE/LTE-A networks, the term evolved Node B (eNB) generally describes the base station 130, while the term UE generally describes the STAs 110. WWAN base station 130 can also be referred to as a base transceiver station, a radio base station, an access point, a radio transceiver, a NodeB, eNodeB (eNB), Home NodeB, a Home eNodeB, or using other suitable terminology. The term “cell” can be used to describe a base station, a carrier or component carrier associated with a base station, or a coverage area (e.g., sector, etc.) of a carrier or base station, depending on context.

A multi-mode STA 110 capable of communicating with both the WLAN 100 and the WWAN base station 130 includes a WLAN RFIC, a WWAN RFIC, a common crystal oscillator, and a baseband circuit. To increase the spatial diversity of WLAN communications, portions of the WWAN receive chain implemented by the WWAN RFIC are repurposed to receive WLAN transmissions together with the WLAN RFIC. Thus, the STA 110 receives and processes a WLAN signal using both WWAN and WLAN paths. The WLAN path of the STA 110 performs gain control estimation, frequency alignment, timing alignment, etc., of the data signal. The WLAN path also provides the timing alignment and gain control information to the WWAN path, which uses this information to receive the WLAN data signal.

The WWAN path time aligns samples of the data signal received via the WWAN path (e.g., via the WWAN antenna(s) and RFIC) with samples of the data signal received via the WLAN path. The WWAN path provides the received WLAN data signal to the WLAN path (e.g., to a WLAN demultiplexer, decoder, deinterleaver, etc.) for processing via the WLAN media access control (MAC) function. Thus, the STA 110 uses the WLAN receive chain to determine alignment parameters for WLAN receptions and uses the alignment parameters in the WWAN path to increase the spatial diversity of WLAN data signal reception. In the configuration where each of the WLAN path and the WWAN path has two antennas, the described techniques double the number of WLAN spatial streams that can be received (e.g., from 2×2 diversity to 4×4 diversity).

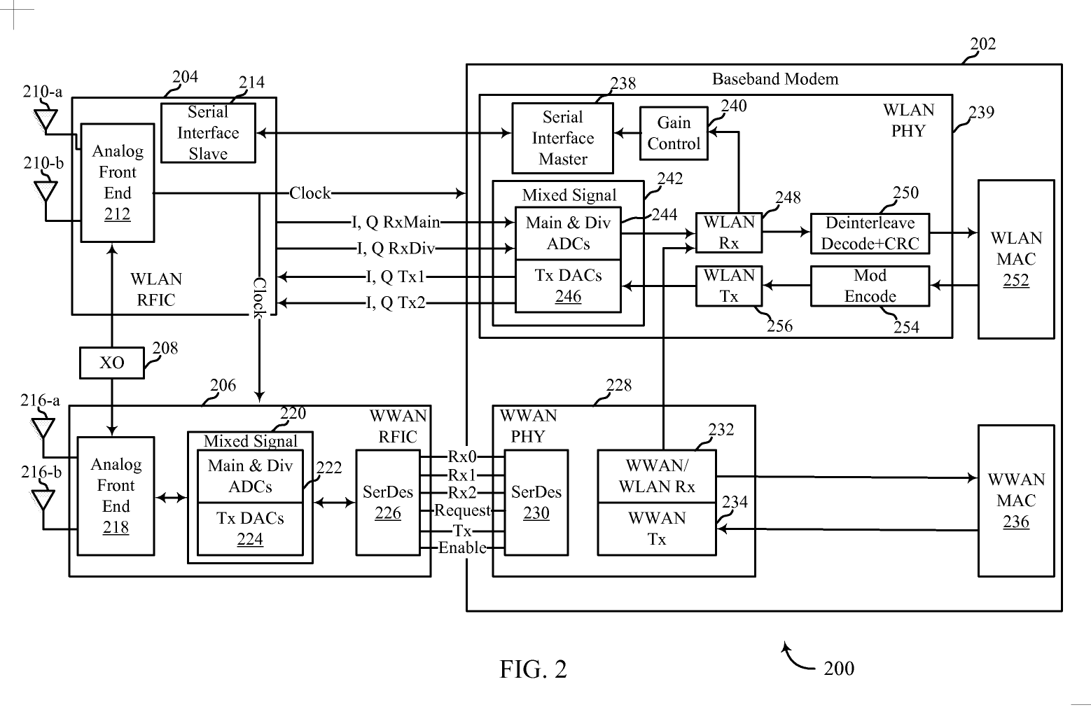

FIG. 2 shows an example of a block diagram of a wireless communication device 200 that supports multi-antenna processing in accordance with various aspects of the present disclosure. The wireless communication device 200 is an example of one or more of the STAs 110 described with reference to FIG. 1. The wireless communication device 200 is a partially converged system that includes a baseband modem 202, a WLAN radio frequency integrated circuit (RFIC) 204, a WWAN RFIC 206, and a shared oscillator 208 such as a crystal oscillator. The wireless communication device 200 supports WLAN communications using the baseband modem 202 and WLAN RFIC 204 and supports WWAN communications, such as cellular communications, using the baseband modem 202 and the WWAN RFIC 206. In addition, the wireless communication device 200 supports reuse of the WWAN RFIC 206 to receive WLAN communications, thereby increasing the spatial diversity of the WLAN communications.

The WLAN RFIC 204 has an analog interface with the baseband modem 202 and includes two antennas 210-a and 210-b (although more or fewer antennas are possible), an analog front end 212, and a serial interface slave 214. For WLAN receive operations using the WLAN RFIC 204, the antennas 210 receive WLAN signals, such as WLAN data signals, and provide the signals to the analog front end 212. One of the antennas 210 is considered a main antenna 210-a and the other of the antennas 210 is considered a diversity antenna 210-b.

The analog front end 212 of the WLAN RFIC 204 receives a timing signal from the shared oscillator 208 or a local oscillator of the analog front end 212 and converts incoming signals from the main antenna 210-a and the diversity antenna 210-b to an intermediate frequency. The analog front end 212 also has impedance matching, filtering, and amplification circuits to condition the incoming signal for processing by the baseband modem 202.

The analog front end 212 provides the filtered, amplified intermediate frequency signals (e.g., the in-phase (“I”) and quadrature components (“Q”) for the main antenna 210-a and the diversity antenna 210-b) to a mixed signal block 242 of the WLAN physical layer 239 of the baseband modem 202. The mixed signal block 242 implements an analog-to-digital conversion (ADC) function for the analog signals from the main antenna 210-a and the diversity antenna 210-b and provides the resulting digital signals to an orthogonal frequency division multiplexing (OFDM) WLAN receiver block 248 for demodulation and OFDM demultiplexing. The demodulated and demultiplexed signals are output from the WLAN receiver block 248 to a deinterleaving, decoding, and cyclic redundancy check (CRC) block 250 to be deinterleaved, decoded, and perform CRC error correction. The decoded WLAN data signals are output to a WLAN media access control (MAC) layer 252 of the baseband modem 202 for communication to higher layers. A serial interface slave 214 of the WLAN RFIC 204 works in combination with a serial interface master 238 of the baseband modem 202 to provide feedback and control signaling, such as gain control signaling from the gain control 240, to the WLAN RFIC 204.

WLAN transmit operations include the WLAN MAC layer 252 receiving data from higher layers and sending the data to a modulation and encoding block 254. Modulated and encoded signals are output from the modulation and encoding block 254 to an OFDM transmitter block 256 for modulation and multiplexing, and the multiplexed signals are output to a digital-to-analog convertor (DAC) 246 of the mixed signal block 242 for conversion to analog signals. The analog signals (e.g., the I/Q for a first transmit stream and the I/Q for a second transmit stream) are output to the WLAN RFIC 204 for transmission via the main antenna 210-a and the diversity antenna 210-b, respectively.

The WWAN RFIC 206 connects to a main antenna 216-a and a diversity antenna 216-b (although more or fewer antennas are possible) and has an analog front end 218, a mixed signal block 220, and a serializer/deserializer (SerDes) 226 digital interface. The analog front end 218 uses a timing signal from the shared oscillator 208 or a local oscillator of the analog front end 218 to convert incoming signals from the main antenna 216-a and the diversity antenna 216-b to an intermediate frequency. The analog front end 218 also has impedance matching, filtering, and amplification circuits to condition the incoming signal for processing by the baseband modem 202

During WWAN receive operations, main and diversity ADCs 222 of a mixed signal block of the WWAN RFIC 206 sample the analog signals from the analog front end 218 and provide corresponding digital signals to the digital interface SerDes 226. The SerDes 226 works in cooperation with a corresponding SerDes 230 on the baseband modem 202 to transmit the digital signals to a WWAN physical layer 228 of the baseband modem 202. The digital signals are received in a WWAN/WLAN receiver 232 of the WWAN physical layer 228 and output to a WWAN MAC layer 236 of the baseband modem 202 for communication to the higher layers.

During WWAN transmit operations, the WWAN MAC layer 236 of the baseband modem 202 receives data from higher layers and provides the data to the WWAN transmitter 234 for modulation, encoding, etc. One or more streams of the modulated and encoded data are provided to the transmit DACs 224 of the mixed signal block 220 of the WWAN RFIC 206, via the digital interfaces SerDes 226 and 230, for conversion to analog signals prior to filtering and amplification at the analog front end 218 for transmission via the antennas 216.

As shown in FIG. 2, the wireless communication device 200 includes two WLAN receive chains or paths and two WWAN receive chains or paths. During WLAN reception, portions of the WWAN receive chains can be repurposed to receive WLAN spatial streams, thereby increasing spatial diversity. Generally, the WLAN RFIC 204 and the WWAN RFIC 206 include separate local oscillators for converting received RF signals to intermediate frequencies. But in the case where both WWAN and WLAN receive chains are used to receive concurrent WLAN signals, the shared oscillator 208 provides a master clock signal that is used by both the WLAN analog front end 212 and the WWAN analog front end 218.

WLAN packet detection is performed using the WLAN RFIC 204, the WLAN PHY layer 239 of the baseband modem 202, and the WLAN MAC layer 252 of the baseband modem 202. The WWAN RFIC is off or in a low-power state until a WLAN packet is detected. Packet detection may be performed by receiving training fields transmitted as a preamble of a frame containing a WLAN packet. When a WLAN packet is detected, the WLAN RFIC 204 and baseband components convey to the WWAN RFIC 206 and WWAN baseband components that a packet has been detected, and the WWAN RFIC 206 powers up and begins receiving during very-high-throughput (VHT)-long training field (LTF) (VHT-LTF) and data regions of the frame containing the WLAN packet. The WLAN signals received at the WWAN/WLAN receiver 232 are then provided to the WLAN receiver block 248 for further processing at the WLAN PHY layer 239 and WLAN MAC layer 252 of the baseband modem.

In some aspects, the WLAN receive chain detects a WLAN packet, triggering the WWAN receive chain to process the packet, e.g., after a delay for the WLAN receive chain path to determine frequency, gain, time, or other alignment features. The WLAN receive chain determines a frequency correction parameter, a timing correction parameter, a gain control parameter, etc., for the WLAN data signal and provides these parameters to the WWAN RFIC 206. The WWAN receive chain uses the parameters to ensure correct processing of the data signal. Common phase error is detected and corrected individually at the different RFICs 204, 206.

Because of the latency introduced by the digital components of the WWAN RFIC 206, WLAN signals received through the WWAN RFIC 206 are time-delayed with respect to corresponding WLAN signals received through the WLAN RFIC 204. Using the shared oscillator 208, a time difference between the WWAN and WLAN receive chains is determined, and the samples received over the WWAN and WLAN receive chains may be time-aligned at an output of the WLAN receiver block 248 of the WLAN PHY layer. In some cases, the WLAN receiver block 248 of the WLAN PHY layer includes a buffer for WLAN data received over the WLAN RFIC 204 to allow for the time alignment of WLAN data received by the different RFICs 204, 206.

The WWAN receive chain receives and processes the WLAN data signal as described above and provides the WLAN data signal to the WLAN receive chain. For example, the WWAN receive chain processes the WLAN signal up to the WWAN/WLAN receiver 232 and then provides the WLAN data signal to the WLAN receiver block 248 for further processing, e.g., using conventional WLAN reception techniques described above. Therefore, in this example, the WLAN receiver block 248 is configured to perform OFDM demultiplexing on four signals rather than the two signals that would otherwise be communicated via the WLAN receive chain. This configuration enables the wireless communication device 200 to leverage four antennas (210-a, 210-b, 216-a, and 216-b) for WLAN reception and processing, which provides four WLAN spatial streams. The four spatial streams can be used to increase throughput (e.g., different data signals communicated over different streams), improve reliability (e.g., add redundancy by having the same data signal communicated over multiple streams), or both.

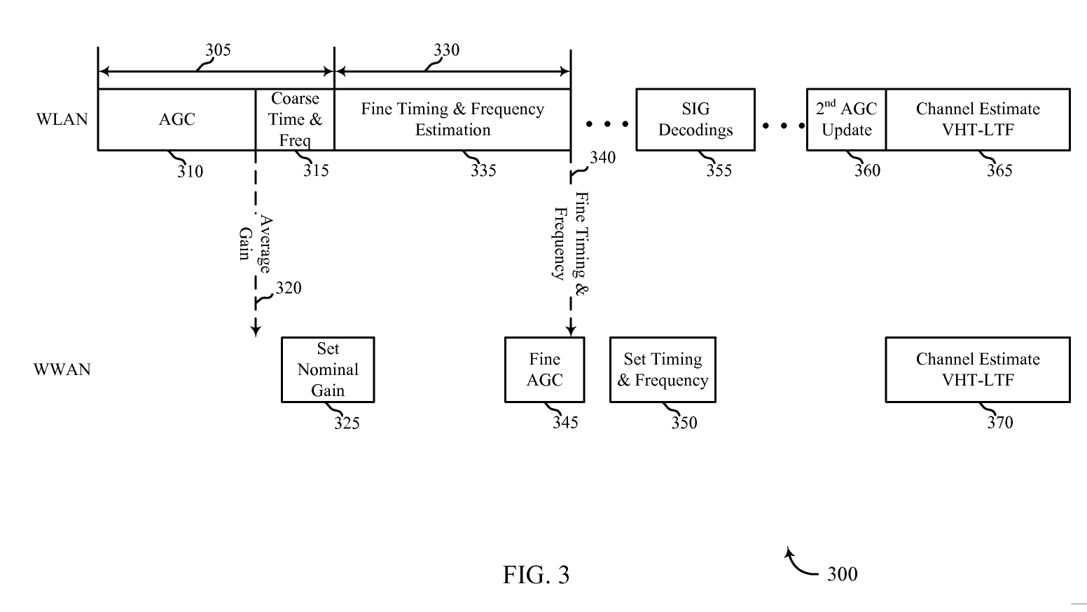

FIG. 3 shows an example of a timing diagram 300 for supports multi-antenna processing in accordance with various aspects of the present disclosure. The timing diagram 300 represents an example of aspects of the WLAN 100 and wireless communication device 200 described with reference to FIGS. 1-2. Timing diagram 300 generally shows illustration of steps performed by a WLAN receive chain (e.g., the WLAN RFIC 204 and baseband modem 202 of FIG. 2) and by a WWAN receive chain (e.g., the WWAN RFIC 206 and baseband modem 202 of FIG. 2).

During a first period 305, the WLAN receive chain receives a WLAN data signal and processes the signal to perform AGC estimation 310 and coarse timing and frequency estimation 315. The WLAN receive chain provides an average gain information element 320 to the WWAN receive chain. The WWAN receive chain sets the nominal gain 325 based on the average gain information element 320. During a second period 330, the WLAN receive chain continues to process the WLAN data signal and performs fine timing and frequency estimation 335. The WLAN receive chain provides the fine timing and frequency estimation 340 to the WWAN receive chain. The WWAN receive chain determines the fine gain control and receives the fine timing and frequency estimation 340 from the WLAN receive chain. The WWAN receive chain sets the fine timing and frequency for the WLAN reception at 350.

In some aspects, the WLAN receive chain performs the functions during periods 305 and 330 based on receiving and decoding a WLAN data signal frame, e.g., the frame preamble and header. For example, the WLAN receive chain determines the AGC estimation and coarse and fine timing and frequency information based on processing a legacy short training field (L-STF), a legacy long training field (L-LTF), a legacy signal field (SIG), a very high-throughput signal A field (VHT-SIG-A), a VHT-STF, etc. Additionally, the WLAN receive chain performs SIG field decoding at 355 and a second AGC update at 360. At 365, the WLAN receive chain processes the channel estimate and VHT-LTF of the WLAN data signal and at 370 the WWAN receive chain processes the channel estimate and VHT-LTF of the WLAN data signal. The VHT-LTF may be followed, in some examples, by a VHT-SIG-B field and then by data. As discussed above, the WWAN receive chain provides the received WLAN data signal to the WLAN receive chain for decoding, deinterleaving, error correction, etc., prior to being passed to higher layers.

In some examples, the WLAN receive chain receives the L-STF and, based on energy detection, determines that a WLAN data signal packet is being received. Based on this determination, the WLAN receive chain begins performing AGC estimation. The WWAN processing path is not engaged at this point, but instead waits for the WLAN receive chain to announce detection of the packet (e.g., WLAN PHY signals the WWAN PHY). The WLAN receive chain uses the L-LTF to being timing and frequency estimation, and also control information. The VHT-SIG-A field is used for channel estimation and data decoding operations. The WLAN receive chain sends the gain, timing, and frequency correction parameters to the WWAN receive chain to align and synchronize the WWAN receive chain for WLAN data signal reception. Each receive chain, e.g., each of the four receive chains associated with antennas 210-a, 210-b, 216-a, and 216-b, may perform common phase error detection and correction. Thus, the four receive chains (two WLAN receive chains and two WWAN receive chains) provide for WLAN data signal reception and decoding.

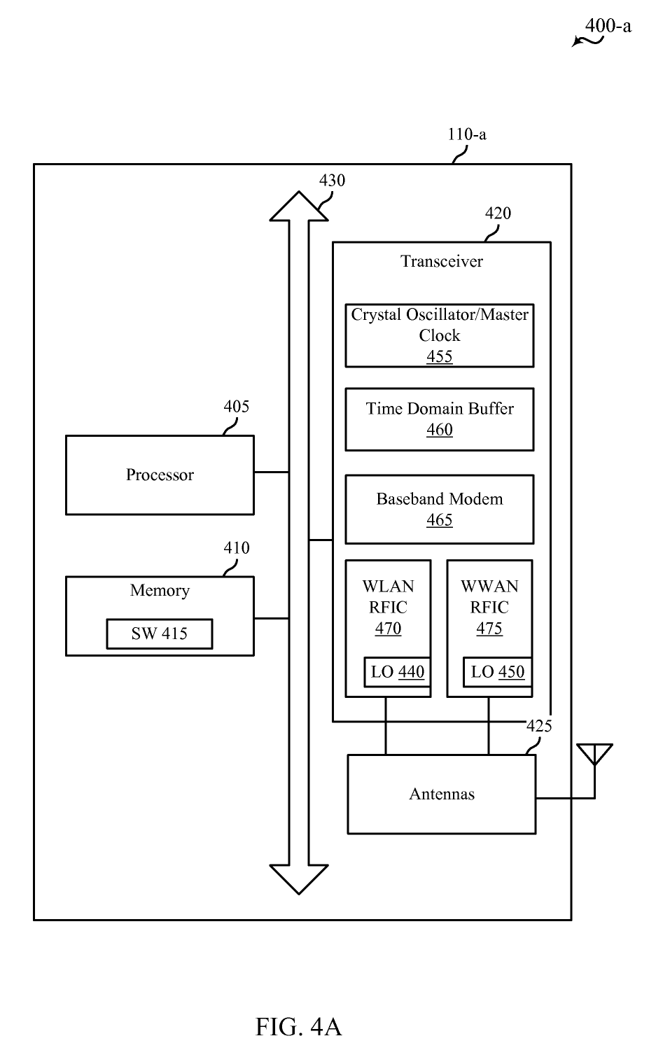

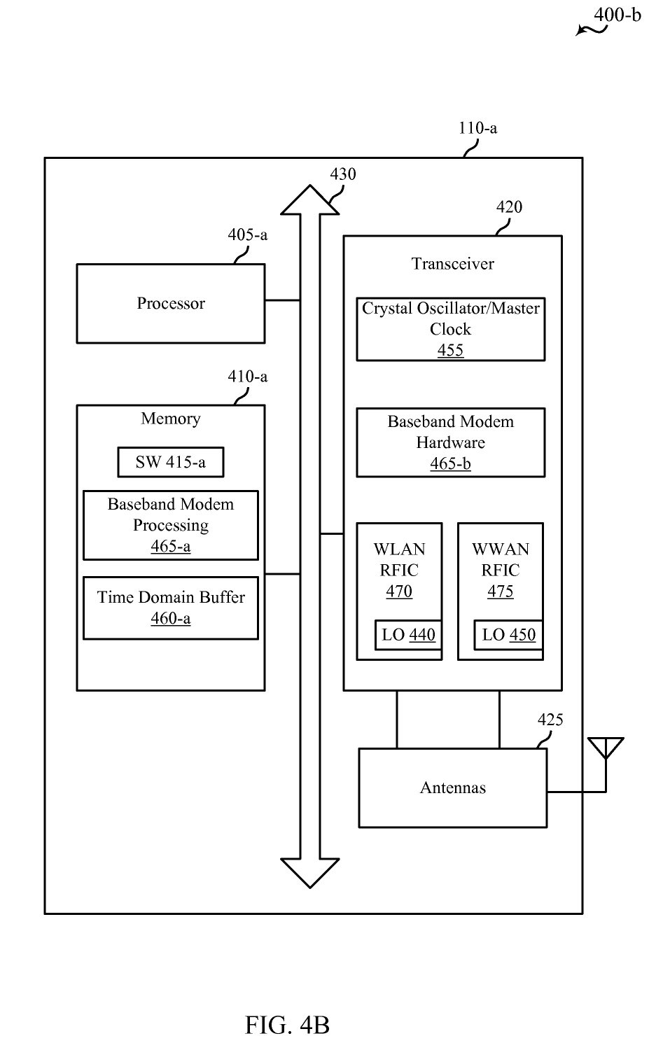

FIG. 4A shows a block diagram 400-a of an example STA 110-a that supports multi-antenna receiver processing in accordance with various aspects of the present disclosure, and with respect to FIGS. 1-3. The STA 110-a includes a processor 405, a memory 410, and a transceiver 420 each of which is communicatively coupled with a bus 430 enabling communication between these components. The antennas 425 are communicatively coupled with the transceiver 420.

The processor 405 is an intelligent hardware device, such as a central processing unit (CPU), a microcontroller, an application-specific integrated circuit (ASIC), etc. The processor 405 processes information received through the transceiver 420 and information to be sent to the transceiver 420 for transmission through the antenna(s) 425.

The memory 410 stores computer-readable, computer-executable software (SW) code 415 containing instructions that, when executed, cause the processor 405 or another one of the components of the STA 110-a to perform various functions described herein, for example, multi-antenna processing for WLAN data signal reception.

The transceiver 420 communicates bi-directionally with other wireless devices, such as APs 105, STAs 110, or other devices. The transceiver 420 includes a baseband modem 465 to encode, interleave, modulate, and multiplex packets and frames for transmission by a WLAN RFIC 470 or a WWAN RFIC 475 over the antennas 425. The baseband modem 465 is additionally used to demodulate, multiplex, deinterleave, and decode packets received from the antenna(s) 425 over WLAN RFIC 470 and/or WWAN RFIC 475, according to the techniques described with reference to FIGS. 1-3 and as further explained below. Each of the WLAN RFIC 470 and the WWAN RFIC 475 has a separate local oscillator 440, 450. The transceiver 420 also includes a master crystal oscillator/shared clock 455 and a time domain buffer 460 to implement the features described with reference to FIGS. 1-3 and as further explained below.

FIG. 4A shows only one possible implementation of a device executing the features of FIGS. 1-3. While the components of FIG. 4A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 4A may be implemented by a single, consolidated hardware block. For example, a single transceiver 420 chip may implement the processor 405, memory 410, time domain buffer 460, baseband modem 465, WLAN RFIC 470, and WWAN RFIC 475.

In still other examples, the features of each component may also be implemented, in whole or in part, with instructions embodied in a memory, formatted to be executed by one or more general or application-specific processors. For example, FIG. 4B shows a block diagram 400-b of another example of a STA 110-b in which baseband modem processing 465-a features and the time domain buffer 460 are implemented as computer-readable code stored on memory 410-a and executed by one or more processors 405-a. Other combinations of hardware/software may be used to perform the features of one or more of the components of FIGS. 4A-4B.

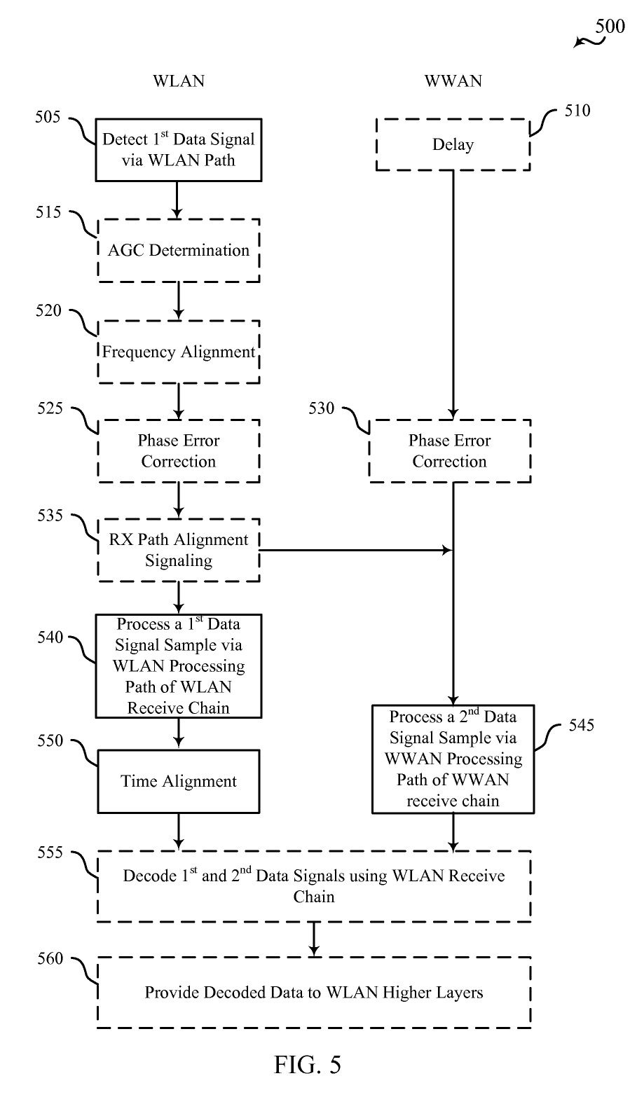

FIG. 5 shows a flow chart that illustrates one example of a method 500 for wireless communication, in accordance with various aspects of the present disclosure. The method 500 may be performed by any of the STAs 110 discussed in the present disclosure, but for clarity the method 500 will be described from the perspective of the STAs 110-a and STA 110-b, of FIGS. 4A and 4B.

Broadly speaking, the method 500 illustrates a procedure by which the STA 110-a or 110-b performs multi-antenna receiver processing by processing a first data signal sample using a WLAN processing path in a first receive chain, processes a second data signal sample using a WWAN processing path in a second receive chain, and time aligns the second data signal sample with the first data signal sample for processing.

The method 500 begins at block 505 with the baseband modem 465 detecting a first WLAN data signal received over the WLAN RFIC 470 and corresponding antennas 425.

The baseband modem 465 detects the data signal based on energy detection during a L-STF field of a preamble of a frame containing a WLAN packet. At 510, the baseband modem 465 delays operations on the WWAN receive chain (e.g., refrains from turning on the WWAN RFIC 475) for a predetermined or known time period or until a signal is received from the WLAN MAC layer to begin processing. The delay includes delaying the reception of the first data signal or a second data signal over the WWAN receive chain until a data portion of the first data signal.

At block 515, the baseband modem 465 determines an AGC function for the first data signal, e.g., during the L-STF portion of the first data signal. At 520, the baseband modem 465 determines a frequency alignment parameter for the first data signal, e.g., during a L-LTF portion of the first data signal.

At block 525, the baseband modem 465 and WLAN RFIC 470 determine phase error correction for the WLAN receive chain. At 530, the baseband modem 465 and WWAN RFIC 475 determine phase error correction for the WWAN receive chain. Each receive chain performs phase error correction separately.

At block 535, the WLAN physical layer of the baseband modem 465 sends receive chain alignment signaling to the WWAN physical layer of the baseband modem 465. The receive chain alignment signaling includes the AGC information, the frequency alignment information, the time alignment information, etc. Although shown in a single step, the receive chain alignment information may be signaled in multiple steps, e.g., as appropriate.

At block 540, the WLAN physical layer of the baseband modem 465 processes a first data signal sample via a WLAN processing path of the WLAN receive chain. The WLAN processing path includes using the AGC, frequency alignment, and phase error correction information to receive, demodulate, and OFDM demultiplex a sample of the first signal.

At block 545, the WWAN physical layer of the baseband modem 465 processes a second data signal sample via the WWAN receive chain. The second data signal sample can be of the first signal received by the WLAN receive chain or of a second signal. The first and second data signal samples can contain overlapping information. The processing includes the WWAN communication manager 435 and the baseband modem 465 using the receive chain alignment information to correct for gain control, frequency alignment, time alignment, etc. Therefore, the WWAN receive chain (e.g., the WWAN RFIC 475 and the WWAN physical layer of the baseband modem 465) is leveraged to receive the second data signal sample (i.e., a WLAN signal).

At block 550, the WLAN physical layer and the time domain buffer 460 buffer the demodulated symbols of the first data signal sample to time align the first data signal sample from the WLAN physical layer with the second data signal sample from the WWAN physical layer.

At block 555, the WLAN physical layer of the baseband modem 465 decodes the first and second data signals. The WLAN physical layer (i.e. a part of the WLAN receive chain) can also perform deinterleaving, error correction, etc. In some examples, the first data signal sample and the second data signal sample are the same WLAN data, e.g., during spatial diversity operations. In some examples, the first data signal sample and the second data signal sample are different WLAN data, e.g., during redundancy operations.

At block 560, the MAC layer of the baseband modem 465 provides the decoded data from the first and second digital signal samples to higher layers (e.g., the data link layer).

The method 500 of FIG. 5 provides for wireless communications at a STA or other communication device. It should be noted that this method is just an example implementation and that the operations thereof may be rearranged or otherwise modified such that other implementations are possible. For example, aspects from the method 500 may be combined with other aspects, such as those described with reference to FIGS. 1-3.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
processing a first data signal sample using a wireless local area network (WLAN) processing path in a first receive chain of a wireless device;
processing a second data signal sample using a wireless wide area network (WWAN) processing path in second receive chain of the wireless device; and
time aligning the second data signal sample with the first data signal sample for data processing.

2. The method of claim 1, further comprising:
delaying the processing of the second data signal sample using the WWAN processing path relative to the processing of the first data signal sample using the WLAN processing path.

3. The method of claim 2, wherein the processing the second data signal sample using the WWAN processing path is delayed a predetermined amount of time.

4. The method of claim 1, further comprising:
detecting a data packet using the WLAN processing path; and
using the packet detection via the WLAN processing path for the processing of the second data signal sample using the WWAN processing path.

5. The method of claim 1, further comprising:
determining a carrier frequency offset correction using the WLAN processing path; and
using the determined carrier frequency offset correction for the processing of the second data signal sample using the WWAN processing path.

6. The method of claim 1, further comprising:
determining a timing using the WLAN processing path; and
using the determined timing for the processing of the second data signal sample using the WWAN processing path.

7. The method of claim 1, further comprising:
determining a first common phase error correction via the processing of the first data signal sample using the WLAN processing path; and
separately determining a second common phase error correction via the processing of the second data signal sample using the WWAN processing path.

8. The method of claim 1, further comprising:
determining a gain control estimation using the WLAN processing path; and
using the determined gain control estimation for initial gain control processing using the WWAN processing path.

9. The method of claim 1, wherein the time alignment comprises:
determining a time difference between processing using the WLAN processing path and processing using the WWAN processing path; and
using the determined time difference to time align the second data signal sample with the first data signal sample.

10. The method of claim 1, further comprising:
receiving a data signal via at least one WLAN antenna;
providing the data signal received via the at least one WLAN antenna to the WLAN processing path;
receiving the data signal via at least one WWAN antenna; and
providing the data signal received via the at least one WWAN antenna to the WLAN processing path.

11. The method of claim 1, further comprising:
receiving a first data signal via at least one WLAN antenna;
providing the first data signal to the WLAN processing path;
receiving a second data signal via at least one WWAN antenna; and
providing the second data signal antenna to the WLAN processing path,
wherein the first data signal and the second data signal are different spatial streams.

12. A wireless device, comprising:
a baseband modem to process a first data signal sample using a WLAN processing path in a first receive chain of the wireless device and process a second data signal sample using a WWAN processing path in a second receive chain of the wireless device; and
a time domain buffer to time align the second data signal sample with the first data signal sample for data processing.

13. The wireless device of claim 12, wherein the baseband modem is further to delay the processing of the second data signal sample using the WWAN processing path relative to the processing of the first data signal sample using the WLAN processing path.

14. The wireless device of claim 13, wherein the processing of the second data signal sample using the WWAN processing path is delayed by a predetermined amount of time.

15. The wireless device of claim 12, wherein the baseband modem is further to detect a data packet using the WLAN processing path; and
wherein the baseband modem is further to use the packet detection via the WLAN processing path for the processing of the second data signal sample using the WWAN processing path.

16. The wireless device of claim 12, wherein the baseband modem is further to determine a carrier frequency offset correction using the WLAN processing path; and
wherein the baseband modem is further to use the determined carrier frequency offset correction for the processing of the second data signal sample using the WWAN processing path.

17. The wireless device of claim 12, wherein the baseband modem is further to determine a timing using the WLAN processing path; and
wherein the baseband modem is further to use the determined timing for the processing of the second data signal sample using the WWAN processing path.

18. The wireless device of claim 12, further comprising:
a WLAN analog front end to determine a first common phase error correction via the processing of the first data signal sample; and
a WWAN analog front end to separately determine a second common phase error correction via the processing of the second data signal sample.

19. The wireless device of claim 12, wherein the baseband modem is further to determine a gain control estimation using the WLAN processing path; and further comprising:
a WWAN analog front end to use the determined initial gain control estimation for gain control processing to receive the second data signal sample.

20. The wireless device of claim 12, wherein the baseband modem is further to determine a time difference between processing using the WLAN processing path and processing using the WWAN processing path and use the time domain buffer to time align the second data signal sample with the first data signal sample based at least in part on the determined time difference.

21. The wireless device of claim 12, wherein the data signal sample and the second data signal sample are of the same spatial stream.

22. The wireless device of claim 12, wherein the data signal sample and the second data signal sample are of different spatial streams.

23. A wireless device, comprising:
means for processing a first data signal sample using a wireless local area network (WLAN) processing path in a first receive chain of the wireless device;
means for processing a second data signal sample using a wireless wide area network (WWAN) processing path in second receive chain of the wireless device; and
means for time aligning the second data signal sample with the first data signal sample for data processing.

24. The wireless device of claim 23, further comprising:
means for delaying the processing of the second data signal sample using the WWAN processing path relative to the processing of the first data signal sample using the WLAN processing path.

25. The wireless device of claim 24, wherein the means for processing the second data signal sample using the WWAN processing path is delayed a predetermined amount of time.

26. The wireless device of claim 23, further comprising:
means for detecting a data packet using the WLAN processing path; and
means for using the packet detection via the WLAN processing path for the processing of the second data signal sample using the WWAN processing path.

27. The wireless device of claim 23, further comprising:
means for determining a carrier frequency offset correction using the WLAN processing path; and
means for using the determined carrier frequency offset correction for the processing of the second data signal sample using the WWAN processing path.

28. The wireless device of claim 23, further comprising:
means for determining a timing using the WLAN processing path; and
means for using the determined timing for the processing of the second data signal sample using the WWAN processing path.

29. The wireless device of claim 23, further comprising:
means for determining a first common phase error correction via the processing of the first data signal sample using the WLAN processing path; and
means for separately determining a second common phase error correction via the processing of the second data signal sample using the WWAN processing path.

30. A non-transitory computer-readable medium storing code for wireless communication at a wireless device, the code comprising instructions executable to cause the wireless device to:
process a first data signal sample using a wireless local area network (WLAN) processing path in a first receive chain of the wireless device;
process a second data signal sample using a wireless wide area network (WWAN) processing path in second receive chain of the wireless device; and
time align the second data signal sample with the first data signal sample for data processing.
